(19) United States
(12) Patent Application Publication
(10) Pub. No.: US 2007/0039022 A1
(43) Pub. Date: Feb. 15, 2007

(54) Method for indicating whether to provide supplementary services through EPG information in a terrestrial DMB system

(75) Inventors: Sun-Mi Kim, Seoul (KR); Jin-Woo Jeon, Seongnam-si (KR); Kyung-Shin Lee, Seoul (KR); Young-Jip Kim, Suwon-si (KR); Byoung-Dai Lee, Seongnam-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/502,648

(22) Filed: Aug. 10, 2006

(30) Foreign Application Priority Data
Aug. 10, 2005 (KR) 73514/2005

(51) Int. Cl. H04N 5/445

(52) U.S. Cl. 725/40; 725/39

(57) ABSTRACT

Disclosed is a method for indicating whether to provide supplementary services through EPG information in a terrestrial DMB system. In this method, a DMB terminal of the terrestrial DMB system receives DMB broadcast data, and extracts the EPG information from the DMB broadcast data. The extracted EPG information is sorted according to service formats of an XML schema for providing the EPG information. Supplementary service information relating to a corresponding program is extracted from the sorted EPG information by means of a program format of the XML schema, and the extracted supplementary service information is stored together with the EPG information. The supplementary service information is provided together with program information of the corresponding program when the EPG information is displayed.

### CLAIM OF PRIORITY

This application claims priority to an application entitled “Method for Indicating Whether to Provide Supplementary Services through EPG Information in Terrestrial DMB System,” filed in the Korean Intellectual Property Office on Aug. 10, 2005 and assigned Serial No. 2005-73514, the contents of which are hereby incorporated by reference.

### BACKGROUND OF THE INVENTION

1. Field of the Invention

The present invention relates to Electronic Programme Guide (EPG) information in a terrestrial DMB Digital Multimedia Broadcasting (DMB) system, and more particularly to a method for providing supplementary service information relating to a main broadcast service through extensible Markup Language-based (XML-based) EPG information in a terrestrial DMB system.

2. Description of the Related Art

A DMB system is a system standard pioneered in Korea for the first time in the world in order to provide a multimedia broadcast service including video based on a Digital Audio Broadcasting (DAB) system, particularly Eureka-147. Eureka-147 is a European digital radio broadcasting standard for simultaneously providing both a high quality audio service of a CD grade and a data service. Further, DMB systems are classified into a satellite DMB system employing a satellite as a transmission medium, and a terrestrial DMB system employing a ground wave as a transmission medium.

The DMB system can provide various information including audio and data as well as video information. Specifically, the terrestrial DMB system services such information by transmitting each of a video service, an audio service and a data service in a frequency tag called an ensemble.

In such a terrestrial DMB system, it is important to provide EPG information. To this end, a proposal has been made to provide information through an XML scheme.

The XML scheme is a method in which the contents and the expressions of a document are separately transmitted. That is, a document writer may create the contents of the document without paying attention to the expressions of the document. Further, the XML scheme is characterized in that one XML document may be expressed in various ways by means of diverse style sheet documents.

The XML document itself targets the structural storage of information rather than the expression of information. Thus, in order to express an XML document, for example, in an HTML (Hyper Text Markup Language) style, it is necessary to separately make a style sheet document such as a CSS (Cascading Style Sheet) and an XSL (eXtensible Style Sheet Language).

FIG. 1 illustrates an example of a typical XML document-providing system for providing EPG information in a terrestrial DMB system.

As illustrated in FIG. 1, the XML document-providing system includes a word processor unit 100 for creating an XML document, a document receiver unit 200 for receiving the created XML document and interpreting the received XML document into a web document style, and a broadcast network 14 for interconnecting the word processor unit 100 and the document receiver unit 200.

The word processor unit 100 converts an input document 11 into the XML document through an XML creator 12, and transfers the XML document to the broadcast network 14. Here, the XML creator 12 expresses a document as only the contents of the document. Thus, in order to represent the XML document as a document such as an HTML document, the word processor unit 100 further includes a CSS/XSL processor 13 for providing a style sheet document.

The document receiver unit 200 interprets the XML document transferred through the broadcast network 14 by means of an XML interpreter 15, and represents the XML document as an HTML style document 16.

In order to generate XML based-EPG information for the terrestrial DMB system, the European Telecommunications Standards Institute (ETSI) has developed an XML-based EPG standard proposal (ETSI TS 101 818) for DAB. In the ETSI TS 101 818, an XML schema for a data broadcast is proposed and thus the XML-based EPG information is configured according to the proposed XML schema.

Generally, EPG information is intended to enable broadcast service users to select desired broadcast services or relevant contents by supplying the users with information about various services available to the users.

Since various types of terminals are used in a broadcast network, such EPG information needs to be flexible. In order to provide EPG information regardless of the types of terminals, the ETSI has defined an XML schema for a DAB service by means of XML.

As described above, the EPG defined by an ETSI is based on a DAB service. Currently, the Telecommunications Technology Association (TTA) in Korea is performing supplementary development for a terrestrial DMB service part, i.e., a video service-related part.

The XML schema defined by the ETSI TS 101 818 according to the DAB standard includes service information, schedule information and group information.

FIGS. 2a to 2c respectively illustrate service information, schedule information and group information according to the XML schema defined in the DAB standard.

FIG. 2a relates to the service information. The service information includes an ensemble tag 21 for specifying information about an ensemble, and a service tag 22 for specifying both information about a broadcast service and link information about an ensemble for which the broadcast service is provided. As illustrated in FIG. 2a, each service tag 22 is connected with an ensemble tag 21, and the service tag 22 is treated as a subordinate tag to the ensemble tag 21. One of the attributes of the service tag 22 is a format. A format defined by the existing DAB standard is as follows: audio (default); Dynamic Label Service (DLS); MOTSlideshow; MOTBWS; Transport Protocol Experts Group (TPEG); and Differential GPS (DGPS).

FIG. 2b relates to the schedule information. The schedule information includes a schedule tag 23 for specifying time information (schedule) for one or more services, a program tag 24 for specifying both information about programs and link information about a service available to a corresponding program, and an event tag 25 for specifying information about events related to a corresponding program. As illustrated in FIG. 2b, the schedule tag 23 is the uppermost tag, the program tag 24 is ranked below the schedule tag 23, and the event tag 25 is the lowermost tag.

FIG. 2c relates to the group information. The group information includes a parents group P tag 26 for specifying information about one group, n Son group S tags 27-1 to 27-n for specifying both the information about one group and link information about upper groups thereof, and a program tag 28 for specifying groups to which the program is linked. As illustrated in FIG. 2c, the group P tag 26 is the uppermost tag, the n group S tags 27-1 to 27-n are ranked next to the group P tag 26, and the program tag 28 is the lowermost tag.

Table 1 is an example of the service information in an XML schema defined by the existing ETSI TS 101 818.

TABLE 1
<xs:element name=“service” minOccurs=“0” maxOccurs=“unbounded”>
<xs:complexType>
<xs:sequence>
<xs:element name=“serviceID” minOccurs=“1”
maxOccurs=“unbounded”>
<xs:complexType>
<xs:attribute name=“id” type=“epg:dabIDType” use=“required”/>
<xs:attribute name=“type” default=“primary”>
<xs:simpleType>
<xs:restriction base=“xs:NMTOKEN”>
<xs:enumeration value=“primary”/>
<xs:enumeration value=“secondary”/>
</xs:restriction>
</xs:simpleType>
</xs:attribute>
</xs:complexType>
</xs:element>
<xs:group ref=“epg:serviceNameGroup” maxOccurs=“unbounded”/>
<xs:element name=“mediaDescription” type=“epg:mediaDescriptionType”
minOccurs=“0” maxOccurs=“unbounded”/>
<xs:element name=“genre” type=“epg:genreType” minOccurs=“0”
maxOccurs=“unbounded”/>
<minOccurs=“0” maxOccurs=“unbounded”/>
<xs:element name=“parentalRating” type=“epg:parentalRatingType”
minOccurs=“0”/>
<xs:element name=“CA” type=“epg:CAType” minOccurs=“0”/>
<xs:element name=“keywords” type=“epg:keywordsType”
minOccurs=“0”/>
<xs:element name=“link” type=“epg:linkType” minOccurs=“0”
maxOccurs=“unbounded”/>
</xs:sequence>
<xs:attribute name=“version” type=“xs:integer”/>
<xs:attribute name=“format” default=“audio”>
<xs:simpleType>
<xs:restriction base=“xs:NMTOKEN”>
<xs:enumeration value=“audio”/>
<xs:enumeration value=“DLS”/>
<xs:enumeration value=“MOTSlideshow”/>
<xs:enumeration value=“MOTBWS”/>
<xs:enumeration value=“TPEG”/>
<xs:enumeration value=“DGPS”/>
<xs:enumeration value=“proprietary”/>
</xs:restriction>
</xs:simpleType>
</xs:attribute>
<xs:attribute name=“bitrate” type=“xs:nonNegativeInteger”/>
</xs:complexType>
</xs:element>
</xs:sequence>
<xs:attribute name=“id” type=“epg:ensembleIDType” use=“required”/>
<xs:attribute name=“version” type=“xs:integer”/>
</xs:complexType>
</xs:element>

The current proposed XML schema is limited in its ability to provide various information to users through such EPG information.

That is, as illustrated in Table 1, the current proposed XML schema is deficient in that its service tag does not specify “video” information and, when a data broadcast is connected with an audio broadcast or a video broadcast, there is no way to represent the data broadcast.

In other words, the current DMB broadcast only provides three types of broadcasts; a video broadcast, an audio broadcast and a data broadcast. Here, the data broadcast refers to a data broadcast through an independent channel. However, in addition to the data broadcast through an independent channel, it is possible to provide a data broadcast through a program-linked service in a video broadcast or an audio broadcast. For example, in an audio broadcast, a Dynamic Label Service (DLS) and an Slide Show Service (SLS) may be used together in a Program Associated Data (PAD) scheme. Further, in a video broadcast, supplementary data broadcasts using Java application programs are expected to increasingly occur. Therefore, in order to seamlessly provide information for a DMB data broadcast, it is necessary to also provide data broadcast service information linked with a main broadcast service, such as, an audio broadcast or a video broadcast, in addition to information about an independent data broadcast, in the EPG.

### SUMMARY OF THE INVENTION

Accordingly, a preferred embodiment of the present invention provides a method for indicating whether a terrestrial DMB system should provide supplementary services through EPG information, and the supplementary services are detected by sorting EPG information provided to the terrestrial DMB system according to main broadcast services, and displaying any detected supplementary services of a corresponding main broadcast service.

The preferred embodiment of the present invention provides a new XML schema for including additional EPG information comprising a format field for representing the existence of a corresponding service and the type of the service for a program-linked supplementary service.

The method for indicating to a terrestrial DMB system whether to provide supplementary services through EPG information comprises the steps of:

receiving DMB broadcast data by a DMB terminal of the terrestrial DMB system;

extracting the EPG information from the DMB broadcast data;

sorting the extracted EPG information according to service formats of an XML schema for providing the EPG information;

extracting supplementary service information relating to a corresponding program from the sorted EPG information by means of a program format of the XML schema;

storing the extracted supplementary service information together with the EPG information; and

providing the supplementary service information together with program information of the corresponding program when the EPG information is displayed.

### BRIEF DESCRIPTION OF THE DRAWINGS

The above and other features and advantages of the present invention will be more apparent from the following detailed description taken in conjunction with the accompanying drawings, in which:

FIG. 1 is a block diagram illustrating an example of a common XML document-providing system for providing EPG information in a terrestrial DMB system;

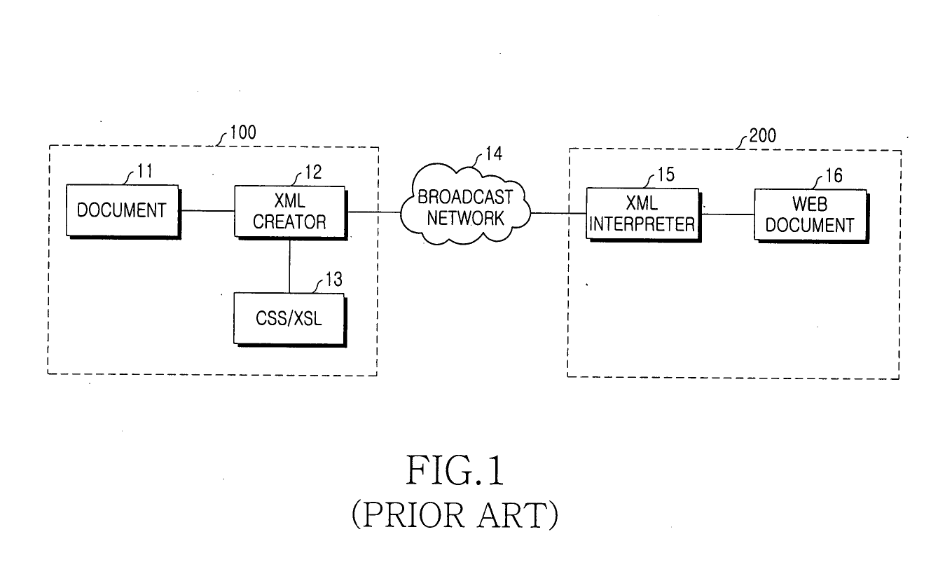

FIGS. 2a, 2b, and 2c are block diagrams respectively illustrating an example of service information, schedule information, and group information according to an XML schema defined by a DAB standard;

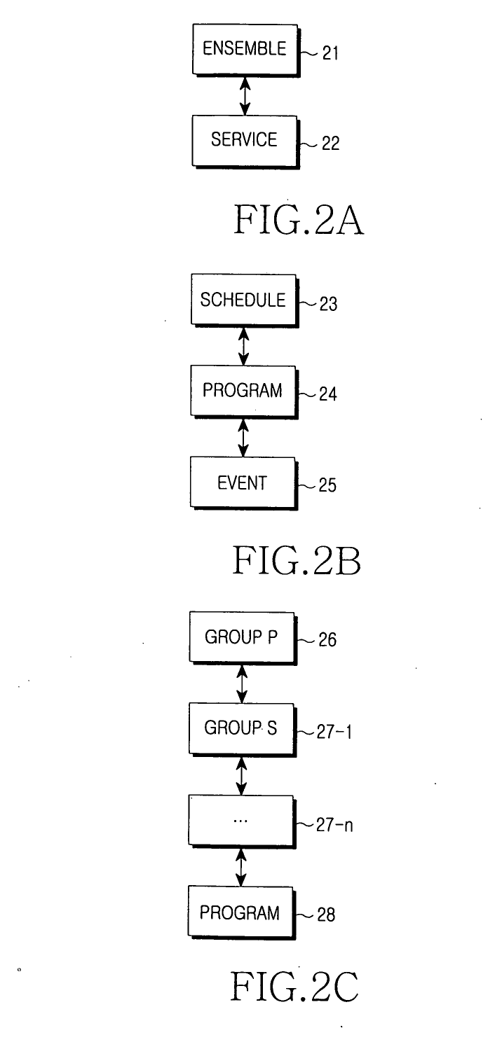

FIG. 3 is an operational flowchart illustrating a method for providing EPG information in a terrestrial DMB system in accordance with a preferred embodiment of the present invention; and

FIG. 4 is a view illustrating an example of a DMB terminal screen on which EPG information is displayed in accordance with a preferred embodiment of the present invention.

### DETAILED DESCRIPTION OF THE INVENTION

Hereinafter, embodiments of the present invention are described with reference to the accompanying drawings. It should be noted that similar components are designated similar reference numerals although these components are illustrated in different drawings. For the purposes of clarity and simplicity, a detailed description of known functions and configurations incorporated herein is omitted when it may obscure the subject matter of the present invention.

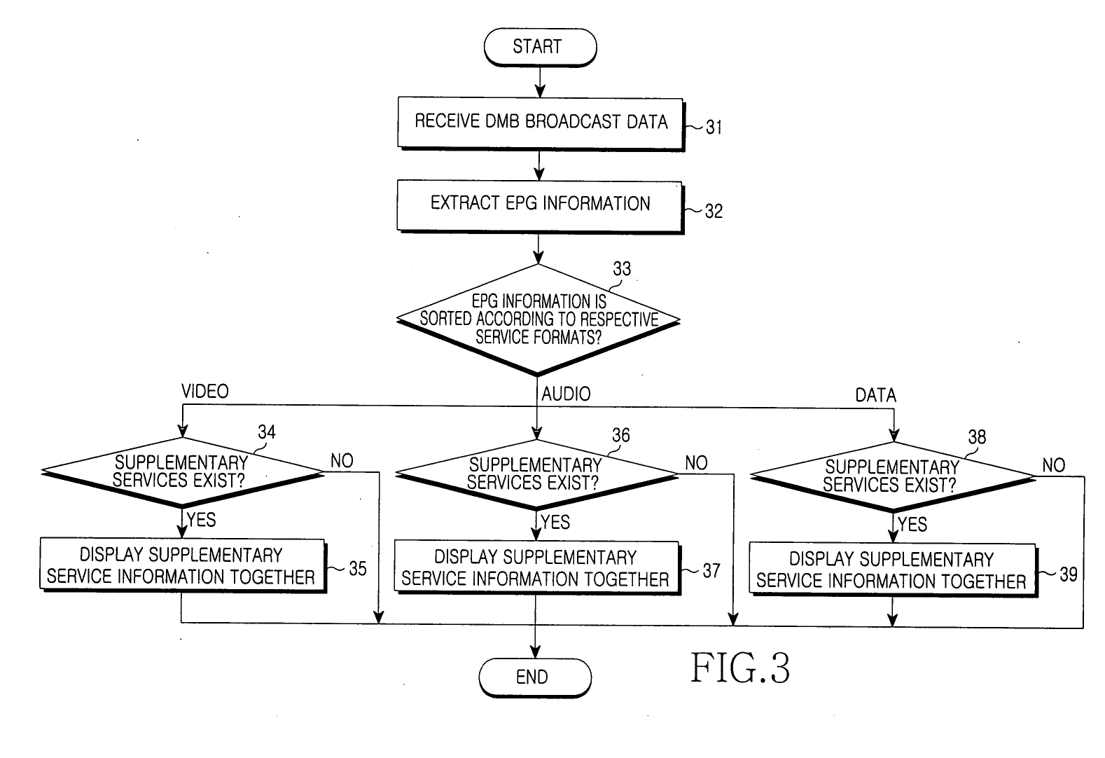

FIG. 3 is an operational flowchart illustrating a method for providing EPG information according to a preferred embodiment of the present invention.

Referring to FIG. 3, a given terrestrial DMB terminal receives DMB broadcast data in a terrestrial DMB system (step 31), and extracts EPG information from the received DMB broadcast data (step 32). Here, the EPG information is received through a Fast Information Channel (FIC) of the DMB broadcast data, which is well known in the art and thus a description thereof is omitted in this embodiment.

The extracted EPG information is sorted according to respective service formats (step 33). Here, the respective service formats refer to three main broadcast services, that is, a video broadcast, an audio broadcast and a data broadcast. These service formats are acquired by analyzing the EPG information defined by an XML schema. However, since an XML schema defined in the existing DAB standard cannot provide information about the video broadcast, the present invention provides an XML schema for supporting a new service format. The provided new service format indicates that a main broadcast service is the video broadcast.

Table 2 presents a new XML schema in which a service format for indicating video broadcast information is newly provided according to the present invention.

TABLE 2
<xs:element name=“service” minOccurs=“0” maxOccurs=“unbounded”>
<xs:complexType>
<xs:attribute name=“format” default=“audio”>
<xs:simpleType>
<xs:restriction base=“xs:NMTOKEN”>
<xs:enumeration value=“video”/>
<xs:enumeration value=“audio”/>
<xs:enumeration value=“DLS”/>
<xs:enumeration value=“MOTSlideshow”/>
<xs:enumeration value=“MOTBWS”/>
<xs:enumeration value=“TPEG”/>
<xs:enumeration value=“DGPS”/>
<xs:enumeration value=“proprietary”/>
</xs:restriction>
</xs:simpleType>
</xs:attribute>
</xs:complexType>
</xs:element>

As presented in Table 2, in addition to six service formats defined in the existing XML schema, that is, “audio (default)”, “DLS” Dynamic Label Service, “MOTSlideshow”, “MOTBWS”, “TPEG” Transport Protocol Experts Group, and “DGPS” Differential GPA, service format “video” is defined in the new XML schema of the present invention.

Through a preferred embodiment of such an additional service format, video, audio and data broadcasts can be easily distinguished from each other.

Further, whether or not supplementary services exist is checked according to the respective broadcast services (steps 34, 36, 38). The existence of the supplementary services is defined by a program tag 24 of the XML schema. Particularly, in the present invention, program format “Type” is added to the existing XML schema to indicate information about supplementary services is provided along with corresponding program services information in the EPG.

Table 3 shows an example of an XML schema to which the new program format according to the present invention is added.

TABLE 3
<!-- ################################################################## -
->
<!-- Definition of ProgrammeFormatType -->
<!-- ################################################################## -
->
<xs:complexType name=“ProgrammeFormatType”>
<xs:sequence>
<xs:element name=“ProgrammeFormat” maxOccurs=“unbounded”>
<xs:complexType>
<xs:attribute name=“type” default=“NORMAL” use=“required”/>
<xs:simpleType>
<xs:restriction base=“xs:NMTOKEN”>
<xs:enumeration value=“NORMAL”/>
<xs:enumeration value=“PAD”/>
<xs:enumeration value=“proprietary”/>
</xs:restriction>
</xs:simpleType>
</xs:attribute>
<xs:attribute name=“format” use=“required”/>
<xs:simpleType>
<xs:restriction base=“xs:NMTOKEN”>
<xs:pattern value=
“((video)|(audio)|(DLS)|(MOTSlideshow)|(MOTBWS)|(TPEG)|(DGPS)|(proprietary))
((,video)|(,audio)|(,DLS)|(,MOTSlideshow)|(,MOTBWS)|(,TPEG)|(,DGPS)|(,proprietary))*”
/>
</xs:restriction>
</xs:simpleType>
</xs:complexType>
</xs:element>
</xs:sequence>
</xs:complexType>

Referring to Table 3, the newly added “Type” defines element “ProgrammeFormat”, and includes a “type” attribute and a “format” attribute.

Here, the “type” attribute indicates whether or not supplementary services exist that are linked with a current program. That is, when the “type” attribute has a value of “NORMAL”, this value indicates that there is no supplementary service linked with a current program. Also, when the “type” attribute has a value of “PAD”, this value indicates that linked supplementary services are transmitted through PAD (Program Associated Data).

In addition, when the “type” attribute has the value of “NORMAL”, the “format” attribute has a value equal to one of the service formats defined above in Table 2, that is, “video”, “audio”, “DLS”, “MOTSlideshow”, “MOTBWS”, “TPEG”, “DGPS” and “proprietary”. In other words, the “format” attribute represents the type of a corresponding program. Further, when the “type” attribute has the value of “PAD”, a corresponding program may have two or more “format” attributes.

Of such two or more “format” attributes, the first value corresponds to a value indicating the type of a main service (this is the same as the service format of a corresponding program), the second value corresponds to other values that indicate the types of linked supplementary services. Since it is possible to provide up to a maximum 12 PAD services in the existing DAB standard, the “format” attribute may have 13 values up to now.

If the existence of the supplementary services is confirmed in steps 34, 36, 38, corresponding supplementary service information is stored together with main service information in the EPG information, and the supplementary service information and the main service information are displayed together when the EPG information is provided (steps 35, 37, 39).

In the foregoing, the definition of a new XML schema necessary for providing EPG information in a terrestrial DMB system has been provided by describing procedures for receiving and processing the EPG information in a terrestrial DMB terminal. Thus, the XML schema is used not only for receiving the EPG information, but is used both in transmitting and in receiving the EPG information by applying its definition to the overall system.

Various methods may be used to display supplementary service information, as defined above, on an EPG screen. Such methods include a method of changing the background color of a corresponding main service according to respective service types (for example, red background color in the case of MOTBWS, blue background color in the case of TPEG, etc.), a method of including an icon in a corresponding main service area according to respective service types (for example, icon \textcircled{b} in the case of MOTBWS, icon \textcircled{p} in the case of TPEG, etc.) and so forth.

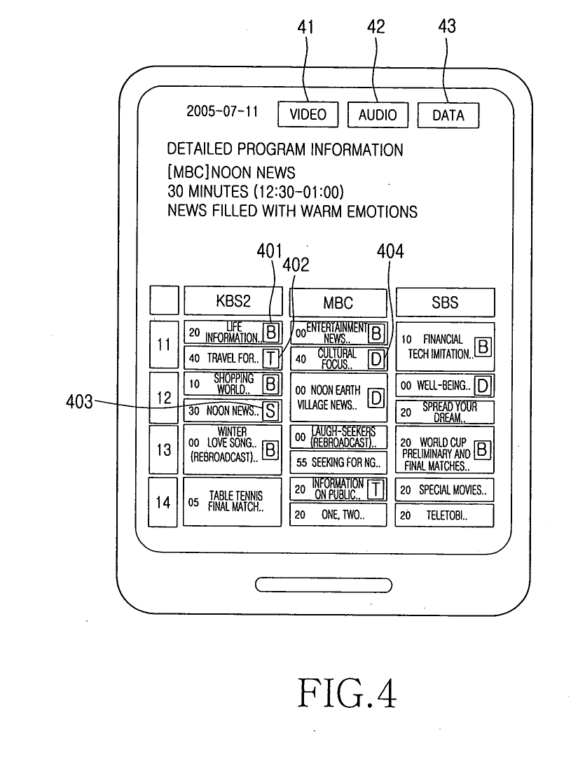

FIG. 4 illustrates an example of a DMB terminal screen on which EPG information is displayed in accordance with a preferred embodiment of the present invention.

Referring to FIG. 4, EPG information can be displayed according to respective main service lists 41, 42, 43 by selecting corresponding main services 41, 42, 43.

In this embodiment of the present invention, it is assumed that a video service (VIDEO) 41 has been selected from among the main services.

In respective programs corresponding to the selected main service, information about whether or not supplementary services exist is displayed in the form of icons 401, 402, 403, 404. Of the icons illustrated in FIG. 4, an icon designated by reference numeral “401” indicates that the information relates to “MOTBWS”, an icon designated by reference numeral “402” indicates that the information relates to “TPEG”, an icon designated by reference numeral “403” indicates that the information related to “MOTSlideshow”, and an icon designated by reference numeral “404” indicates that the information relates to “Dynamic Label”.

As stated above, the present invention includes a “video” format, a new service format according to a DMB service in an XML schema for providing EPG information in a terrestrial DMB system, and the present invention newly defines element “ProgrammeFormat” for indicating supplementary service information relating to respective program formats, thereby making it possible to easily ascertain the existence of supplementary services through EPG information.

When the EPG information is provided in a manner as described above, it is necessary to provide a plurality of “format” information for one service. Therefore, in a preferred embodiment of the present invention, a new type called “formatType” is defined, the type of “format” is changed to the newly defined “formatType” in the existing XML schema for a service tag within service information as shown in Table 1, and an XML file for the service tag is set up such that the format has a plurality of values.

Table 4 is an XML schema defining a value of the “formatType” included in a service tag newly defined in the embodiment of the present invention.

TABLE 4
<!--#####################################################-->
<!--Definition of formatType-->
<!--#####################################################-->
<xs:simpleType name=“formatType”>
<xs:restriction base=“xs:string”>
<xs:whiteSpace value=“collapse”/>
<xs:pattern
value=“((video)|(audio)|(DLS)|(MOTSlideshow)|(MOTBWS)|
(TPEG)|(DGPS)|(proprietry))
((,video)|(,audio)|(,DLS)|(,MOTSlideshow)|(,MOTBWS)|(,TPEG)|
(,DGPS) (proprietry))*”/>
</xs:restriction>
</xs:simpleType>

In this way, a schema defined by the “format” attribute of a service tag may be defined and used as a separate type. For example, the “formatType” defined in Table 4 may be defined and used as the type of a “format attribute value” in the schema for service information shown in Table 2.

This newly defined “formatType” provides a simplified and standardized schema by defining duplicate schema contents by one type.

Table 5 shows an example of applying the newly defined “formatType” to the format attribute of a service tag.

TABLE 5
<xs:element name=“service” minOccurs=“0” maxOccurs=“unbounded”>
<xs:complexType>
<xs:attribute name=“format” type=“formatType” default=“audio” />
</xs:complexType>
</xs:element>

Further, it is also possible to apply the newly defined “formatType” to the format attribute of a program format type” in Table 3.

Table 6 shows an XML schema in the case where the newly defined “formatType” is used as the format attribute of a “program format type”.

TABLE 6
<!--###################################################-->
<!-- Definition of programmeFormatType -->
<!--################################################### -->
<xs:complexType name=“programmeFormatType”>
<xs:sequence>
<xs:element name=“programmeFormat” maxOccurs=“unbounded”>
<xs:complexType>
<xs:attribute name=“type” use=“required”>
<xs:simpleType>
<xs:restriction base=“xs:NMTOKEN”>
<xs:enumeration value=“normal”/>
<xs:enumeration value=“PAD”/>
<xs:enumeration value=“BIFS”/>
<xs:enumeration value=“proprietary”/>
</xs:restriction>
</xs:simpleType>
</xs:attribute>
<xs:attributename=“format” type=“formatType” use=“required”/>
</xs:complexType>
</xs:element>
</xs:sequence>
</xs:complexType>

The method of the present invention can be implemented as a computer readable program and stored in a recording medium (CD-ROM, RAM, floppy disk, hard disk, optical magnetic disk, etc.).

As described above, according to the present invention, whether to provide supplementary services is indicated in EPG information provided to a terrestrial DMB system which then sorts the EPG information according to main broadcast services, and detects and displays any existing supplementary services of a corresponding main broadcast service.

Further, whether or not to provide supplementary services by a terrestrial DMB system is also indicated by adding a format field to an XML schema for providing EPG information that represents the existence of a corresponding service and the type of the service for a program-linked supplementary service.

Although preferred embodiments of the present invention has been described for illustrative purposes, those skilled in the art will appreciate that various modifications, additions and substitutions are possible, without departing from the scope and spirit of the invention as disclosed in the accompanying claims, including the full scope of equivalents thereof.

What is claimed is:

1. A method for indicating whether to provide supplementary services through EPG information in a terrestrial DMB system, the method comprising the steps of:
defining an XML schema having service formats for providing EPG information;
receiving DMB broadcast data by a DMB terminal of the terrestrial DMB system;
extracting the EPG information from the received DMB broadcast data by the DMB terminal;
sorting the extracted EPG information by the DMB Terminal according to the service formats of the defined XML schema;
extracting supplementary service information relating to a corresponding program from the sorted EPG information by means of a program format of the defined XML schema;
storing the extracted supplementary service information together with the EPG information both relating to the corresponding program; and
providing the stored supplementary service information together with program information of the corresponding program when the EPG information is displayed.

2. The method as claimed in claim 1, wherein the providing step further comprises the steps of:
first converting the supplementary service information into an icon; and
storing the converted icon with program information such that the converted icon is displayed in the program information of the corresponding program when the EPG information is displayed.

3. The method as claimed in claim 1, wherein the providing step further comprises the steps of:
assigning a unique color to the supplementary service information of a corresponding program; and
displaying the supplementary service information in the program information of the corresponding program by displaying a background color of the program information as the assigned unique color.

4. The method as claimed in claim 1, wherein the defining step further comprises the step of additionally defining a “video” format as one of a plurality of service formats in the XML schema for providing the EPG information.

5. The method as claimed in claim 4, wherein the XML schema that defines the plurality of service formats in which the “video” format is additionally defined, comprises the following table:
<xs:element name=“service” minOccurs=“0” maxOccurs=“unbounded”>
<xs:complexType>
<xs:attribute name=“format” default=“audio”>
<xs:simpleType>
<xs:restriction base=“xs:NMTOKEN”>
<xs:enumeration value=“video”/>
<xs:enumeration value=“audio”/>
<xs:enumeration value=“DLS”/>
<xs:enumeration value=“MOTSlideshow”/>
<xs:enumeration value=“MOTBWS”/>
<xs:enumeration value=“TPEG”/>
<xs:enumeration value=“DGPS”/>
<xs:enumeration value=“proprietary”/>
</xs:restriction>
</xs:simpleType>
</xs:attribute>
</xs:complexType>
</xs:element>

6. The method as claimed in claims 1, wherein the defining step further comprises the step of in order to extract the supplementary service information from the XML schema for a program format, defining a “ProgrammeFormat” element that includes the supplementary service information for the program format.

7. The method as claimed in claim 6, wherein the XML schema that defines the “ProgrammeFormat” element that includes the supplementary service information comprises the following table:
<!-- ################################################################## -
->
<!-- Definition of ProgrammeFormatType -->
<!-- ################################################################## -
->
<xs:complexType name=“ProgrammeFormatType”>
<xs:sequence>
<xs:element name=“ProgrammeFormat” maxOccurs=“unbounded”>
<xs:complexType>
<xs:attribute name=“type” default=“NORMAL” use=“required”/>
<xs:simpleType>
<xs:restriction base=“xs:NMTOKEN”>
<xs:enumeration value=“NORMAL”/>
<xs:enumeration value=“PAD”/>
<xs:enumeration value=“proprietary”/>
</xs:restriction>
</xs:simpleType>
</xs:attribute>
<xs:attribute name=“format” use=“required”/>
<xs:simpleType>
<xs:restriction base=“xs:NMTOKEN”>
<xs:pattern value=
“((video)|(audio)|(DLS)|(MOTSlideshow)|(MOTBWS)|(TPEG)|(DGPS)|(proprietary))
((,video)|(,audio)|(,DLS)|(,MOTSlideshow)|(,MOTBWS)|(,TPEG)|(,DGPS)|(,proprietary))*”
/>
</xs:restriction>
</xs:simpleType>
</xs:complexType>
</xs:element>
</xs:sequence>
</xs:complexType>
